(19) United States
(12) Patent Application Publication
(10) Pub. No.: US 2008/0263193 A1
(43) Pub. Date: Oct. 23, 2008

(54) System and Method for Automatically Providing a Web Resource for a Broken Web Link

(76) Inventors: Glen E. Chalemin, Austin, TX (US); Alfredo V. Mendoza, Georgetown, TX (US); Clifford J. Spinac, Austin, TX (US); Tiffany L. Winman, Phoenix, AZ (US)

Correspondence Address: IBM CORP. (WIP);c/o WALDER INTELLECTUAL PROPERTY LAW, P.C., 17330 PRESTON ROAD, SUITE 100B, DALLAS, TX, 75252, US

(21) Appl. No.: 11/736,052

(22) Filed: Apr. 17, 2007

(51) Int. Cl. G06F 15/173

(52) U.S. Cl. 709/224

(57) ABSTRACT

A system and method for automatically providing a Web site resource for a broken Web link are provided. Mechanisms are provided for locating Web site resources that have been moved to a new location in a Web site structure in response to receiving a request directed to an old location of the Web site resource, such as via a broken link. Index data structures of Web site structures are used to identify the structure of the Web site at various times. The index data structures are compared to determine how the Web site structure has been changed and these changes are stored as entries in a differences data structure. The differences data structure is then used to locate a moved Web site resource in the event that a request directed to an old location of the Web site resource is received, such as by selection of a broken link.

### BACKGROUND

1. Technical Field

The present application relates generally to an improved data processing system and method. More specifically, the present application is directed to a system and method for automatically providing a Web resource for a broken Web link.

2. Description of Related Art

Generally, commercial Web sites consist of a large amount of static and dynamic content such as Hypertext Markup Language (HTML) content, pictures, graphics, sound and video files, and Web applications. Due to the rapid and frequent changes to Web site content, typically on a daily basis, Web sites have to be modified accordingly in order to reflect the most up to date information. Such modifications include changing and relocating the content of the HTML, picture, graphics, audio, and video files, and deleting the old static and/or dynamic files.

Typically, such changes, relocation, and the like, is left up to individuals known as Webmasters. The Webmaster's primary role is to keep Web sites up to date and manage the operation of the Web site on a daily basis. When changes are to be made to a Web site, it is up to the Webmaster to update the HTML files, picture files, graphics files, audio files, video files, and the like and to ensure that all references to the modified or relocated content are properly updated.

It can be seen that with rapid and frequent changes to Web site content, even with very simple Web sites, it may be difficult to completely identify every reference, e.g., hyperlinks and the like, to content that has been changed or relocated. Moreover, at present, Web browsers and Web servers do not know whether a reference to Web site content may be obsolete, i.e. the Web site content is no longer accessible by the reference. Such obsolete references are typically referred to as “broken links.” When a reference to content that has been changed or relocated is accessed by a user, the result may be an error due to the content no longer being present at the particular location, with the same filename, or the like, identified in the reference.

For example, originally, a file may be located at the following Uniform Resource Locator (URL): http://www.ibm.com/ondemand/whitepapers/ondemand.pdf During maintenance, directory restructuring, or the like, the file corresponding to this URL may be moved to a new location corresponding to the URL: http://www.ibm.com/ondemand/whitepapers/innovation/ondemand.pdf If a user has bookmarked the original URL and then tries to use the bookmark that points to the original URL after the file has been moved, an error page will be generated and returned to the user's Web browser client application. Similarly, if the user selects a hyperlink or the like, in a Web page that points to the old URL, a similar error page will be generated.

Receiving such error pages becomes frustrating to users of Web browsers since they do not provide any information for the user to find the desired Web content. The user basically feels as if he/she has hit a wall or roadblock and cannot proceed any further.

In order to avoid such error pages being presented to users attempting to access Web content, Web content providers are forced to manually create a re-direct method or provide a variety of error feedback mechanisms, such as a re-direct to a generic top-level Web page of a Web site or a Web page listing error types. However, none of these mechanisms allow a user to immediately access the desired Web content. To the contrary, the user is forced to go through a number of operations to attempt to correct the error and find the Web content for which they are looking.

Due to the ineffectiveness of these mechanisms, the Web browser user does not achieve his/her goals of accessing the desired Web content. As a result, they become confused and frustrated and possibly do not return to the offending Web site. Moreover, the Web site owner/operator has not met the needs of their targeted customers and Web site objectives. Furthermore, the Web site owner/operator may possibly hurt their overall image and “brand loyalty,” and sometimes overall business revenue, by not identifying all broken links in their Web sites.

### SUMMARY

The illustrative embodiments provide a system and method for automatically providing a Web resource for a broken Web link, e.g., hyperlink or other user selectable reference to a Web resource. The mechanisms of the illustrative embodiments provide functionality for locating requested Web site resources, e.g., Web pages, files, or other resources, that have been moved on a Web server and would normally cause a broken link error message to be returned to the Web browser client application. The mechanisms of the illustrative embodiments index the contents of the Web server and create difference files based on movement of the Web site resources. These difference files are then used to locate the Web site resources associated with broken links and return a replacement Web site resource, corresponding to the requested Web site resource, in response to an original request directed to the broken link.

The mechanisms of the illustrative embodiments provide functionality for locating requested Web pages, files, or other Web resources that have been moved on a Web server and would normally cause a broken link error message, e.g., a 404 error Web page, to be returned to the Web browser client application. The mechanisms of the illustrative embodiments index the contents of the Web site and/or Web server and create difference files based on movement of the Web site and/or Web server content. These difference files are then used to locate the Web site resources associated with broken links and return a replacement Web resource, corresponding to the requested Web site resource, in response to an original request directed to the broken link.

In one illustrative embodiment, a Web server is provided with a Web resource location engine which locates Web site resources that have been moved with regard to a Web site in the event that a broken link is accessed by a user of a client device. In one illustrative embodiment, the Web resource location engine of the Web server, on a recurring basis, such as at a regularly scheduled time, scans all the data structures, files, and directories in the Web server's document root, i.e. the directory that forms the main document tree visible from the Web, to create an index data structure of the paths to the various data structures, files, and directories. The Web resource location engine generates a consistency value, e.g., a checksum or cyclic redundancy check (CRC) value, based on content of the individual data structures and/or files and records this consistency value (e.g., checksum or CRC value) along with the data structure or file's full pathname in the index data structure.

The Web resource location engine of the Web server creates a difference data structure, e.g., a difference file, which is used to compare old and new index table data structures. This difference data structure is used to track and determine the current location of a Web resource, e.g., a data structure, file, or the like, that may have been moved recently.

When a Web browser client application request for a Web page or other Web resource is received by the Web server and the Web page or Web resource has been moved from the location identified in the browser request, e.g., the URL specified in the browser request, rather than returning an error page, the Web resource location engine of the Web server uses the difference file to search for a new location of the requested Web page or Web resource. First, the difference file is used to determine if the Web page or Web resource (hereafter referred to collectively as a Web site resource) still exists. If not, a standard error page may be returned to the requestor, e.g., a 404 error page. If the Web site resource does exist, but is in a different location/directory, then the Web resource location engine of the Web server identifies a matching replacement Web site resource by comparing the name and the consistency value (e.g., checksum or CRC value) of the originally requested Web site resource with the candidate Web site resource's name and consistency value. The Web resource location engine of the Web server may then return the replacement Web site resource in response to the original request to the Web browser client application of the requester client device.

For example, assume that the Web document located at http://www.ibm.com/ondemand/whitepapers/ondemand.pdf were moved to a new location corresponding to http://www.ibm.com/ondemand/whitepaper/strategy/ondemand.pdf Moreover, assume that an index and difference file were created to show the document file's current location. When a user clicks on a link to the former location or URL, or selects a bookmark to the former location or URL, for example, the user may be automatically redirected by the Web server to the new location of the Web document based on an examination and comparison with the difference file. In this way, rather than returning an error page simply because a Web site resource has been relocated, the present invention as illustrated in the illustrative embodiments provides mechanisms for reducing the frustration of users by automatically locating the requested Web site resource at its new location and returning it in response to the original request directed to the old location.

In one illustrative embodiment, a method for locating a Web site resource of a Web site is provided. The method may comprise receiving a request for the Web site resource. The request may specify a first location of the Web site resource. The method may further comprise determining if the Web site resource is present at the first location and searching a differences data structure for the Web site resource if the Web site resource is not present at the first location. The differences data structure may comprise entries identifying relocation of the Web site resource within a structure of a Web site. The method may also comprise providing a replacement Web site resource, corresponding to the Web site resource requested in the request, in response to finding the Web site resource in the differences data structure. The replacement Web site resource may be located at a second location within the structure of the Web site different from the first location.

The method may further comprise indexing Web site resources of the Web site to thereby generate an index data structure identifying a current location of Web site resources of the Web site and generating the differences data structure based on the index data structure. Generating the differences data structure may comprise comparing the index data structure to a previously generated index data structure and identifying one or more differences in the location of Web site resources based on the comparison of the index data structure to the previously generated index data structure. One or more entries may be stored in the differences data structure identifying a current location of Web site resources based on the one or more identified differences in the location of Web site resources.

The method may further comprise monitoring editing or modification of a structure of the Web site. Indexing Web site resources may be automatically performed in response to a determination that the structure of the Web site has been modified.

The index data structure may comprise one or more entries, each entry having a full path name of a Web site resource and a consistency value generated based on content of the Web site resource. The differences data structure may comprise a group of entries for at least one Web site resource. The group of entries for the at least one Web site resource may identify a history of locations of the Web site resource in a structure of the Web site.

Searching the differences data structure may comprise searching the differences data structure for an entry that matches a path structure and resource identifier of the Web site resource. Searching the differences data structure may further comprise determining if a matching entry in the differences data structure is found and returning an error response if a matching entry is not found.

Searching the differences data structure may further comprise retrieving an original consistency value from the matching entry if a matching entry in the differences data structure is found and identifying a new path structure entry for the Web site resource by performing a look-up operation in the differences data structure based on the filename of the Web site resource. Searching the differences data structure may also comprise comparing the original consistency value to a consistency value associated with the new path structure entry and returning the new path structure entry as the second location of the Web site resource if the original consistency value matches the consistency value associated with the new path structure entry. A prompt message may be sent to an originator of the request for the Web site resource in response to the original consistency value not matching the consistency value associated with the new path structure entry. The prompt message may request that a user indicate whether a replacement Web site resource whose consistency value does not match an original consistency value of the Web site resource should be provided.

In other illustrative embodiments, a computer program product comprising a computer useable medium having a computer readable program is provided. The computer readable program, when executed on a computing device, causes the computing device to perform various ones, and combinations of, the operations outlined above with regard to the method illustrative embodiment.

In yet another illustrative embodiment, a data processing system is provided. The system may comprise a processor and a memory coupled to the processor. The memory may comprise instructions which, when executed by the processor, cause the processor to perform various ones, and combinations of, the operations outlined above with regard to the method illustrative embodiment.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an exemplary diagram of an exemplary distributed data processing system in which aspects of the illustrative embodiments may be implemented;

FIG. 2 is a block diagram of an exemplary data processing system in which aspects of the illustrative embodiments may be implemented;

FIG. 3 is an exemplary diagram illustrating an operation of one illustrative embodiment with regard to handling a broken link to a Web resource;

FIG. 4 is an exemplary diagram of an index data structure in accordance with one illustrative embodiment;

FIG. 5 is an exemplary diagram of a differences data structure in accordance with one illustrative embodiment;

FIG. 6 is an example of a log data structure in accordance with one illustrative embodiment;

FIG. 7 is an exemplary block diagram of the primary operational components of a Web site resource location engine in accordance with one illustrative embodiment;

FIG. 8 is a flowchart outlining an exemplary operation for automatically generating an index and differences data structure in accordance with one illustrative embodiment; and

FIGS. 9A-9B are flowcharts outlining an exemplary operation for locating a Web site resource in accordance with one illustrative embodiment.

### DETAILED DESCRIPTION OF THE ILLUSTRATIVE EMBODIMENTS

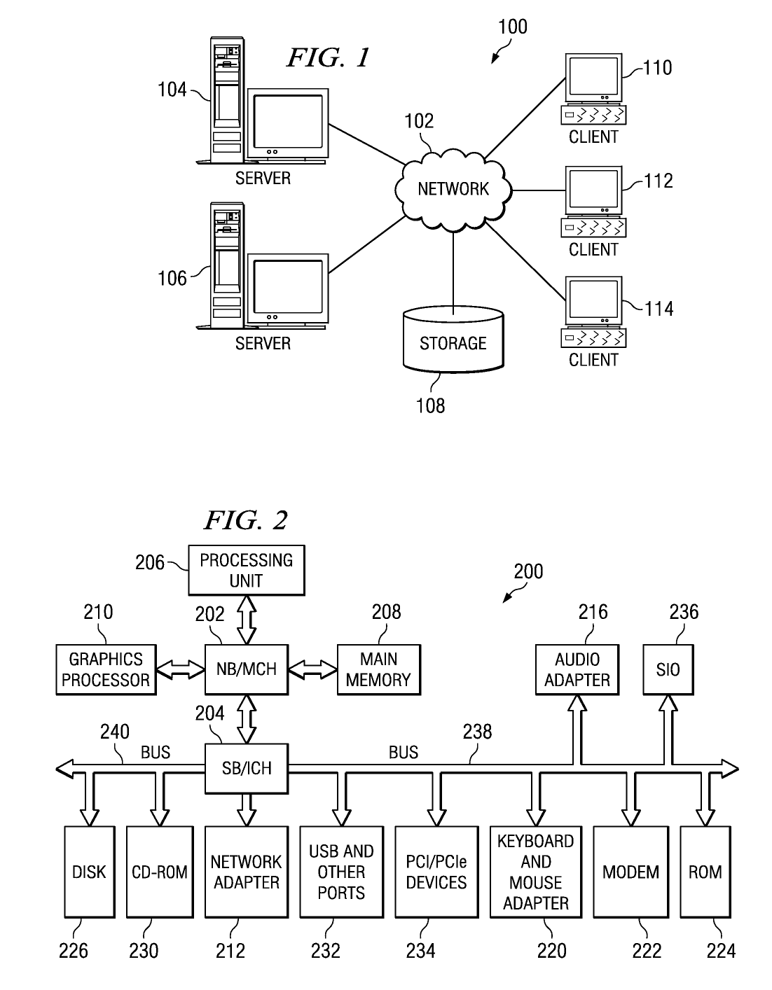

The illustrative embodiments provide mechanisms for automatically providing a Web site resource for a broken Web link, e.g., a hyperlink or other reference to a Web site resource that is no longer existent or has been moved to another location/directory. As such, the mechanisms of the illustrative embodiments are especially well suited for implementation in a distributed data processing system in which Web pages or other Web site resources are made available by one or more Web server computing devices to one or more client computing devices via Web browser client applications running on the one or more client computing devices. Therefore, in order to provide a context for understanding the operation of the specific mechanisms of the illustrative embodiments as described hereafter, FIGS. 1-2 will first be presented as exemplary environments in which the mechanisms of the illustrative embodiments may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 is an exemplary representation of a distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an exemplary data processing system is shown in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ pSeries™ or System p™ computer system, running the Advanced Interactive Executive (AIX™) operating system or the LINUX® operating system (eServer, pSeries or System p and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed. Moreover, data processing system 200 may be a Non-Uniform Memory Access (NUMA) system, or any of a plethora of other data processing systems that may be used as server data processing systems.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the present invention.

Moreover, data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

The mechanisms of the illustrative embodiments provide functionality for locating requested Web pages, files, or other Web site resources that have been moved on a Web server and would normally cause a broken link error message, e.g., a 404 error Web page, to be returned to the Web browser client application. The mechanisms of the illustrative embodiments index the contents of the Web site and/or Web server and create difference files based on movement of the Web server content. These difference files are then used to locate the Web site resources associated with broken links and return a replacement Web site resource, corresponding to the requested Web site resource, in response to an original request directed to the broken link, if possible.

In one illustrative embodiment, a Web server, such as server 104 or 106 in FIG. 1 above, is provided with a Web resource location engine which locates Web site resources that have been moved with regard to a Web site in the event that a broken link is accessed by a user of a client device, such as client device 110, 112, or 114. In one illustrative embodiment, the Web resource location engine of the server 104 or 106, on a recurring basis, such as at a regularly scheduled time, scans all the data structures, files, and directories in the Web server's document root to create an index data structure of the paths to the various data structures, files, and directories. The Web resource location engine generates a consistency value, e.g. a checksum or cyclic redundancy check (CRC) value, for the individual data structures and/or files and records this consistency value (e.g., checksum or CRC value) along with the data structure or file's full pathname in the index data structure.

The Web resource location engine of the server 104 or 106 creates a difference data structure, e.g., a difference file, which is used to compare old and new index table data structures. This difference data structure is used to track and determine the current location of a Web site resource, e.g., a data structure, file, or the like, that may have been moved recently.

When a Web browser client application request for a Web page or other Web site resource is received by the server 104 or 106, such as from a Web browser client application running on one or more of the client devices 110, 112, or 114, and the Web page or Web site resource has been moved from the location identified in the browser request, e.g., the URL specified in the browser request, rather than returning an error page, the Web resource location engine of the server 104 or 106 uses the difference file to search for a new location of the requested Web page or Web site resource. First, the difference file is used to determine if the Web page or Web site resource (hereafter referred to collectively as a Web site resource) still exists. If not, a standard error page may be returned to the requester, e.g., a 404 error page. If the Web site resource does exist, but is in a different location/directory, then the Web resource location engine of the server 104 or 106 identifies a matching replacement Web site resource by comparing the name and the consistency value of the originally requested Web site resource with the candidate Web site resource's name and consistency value. The Web resource location engine of the server 104 or 106 may then return the replacement Web site resource in response to the original request to the Web browser client application of the client device 110, 112, or 114.

In this way, rather than returning an error page simply because a Web site resource has been relocated, the present invention as illustrated in the illustrative embodiments provides mechanisms for reducing the frustration of users by automatically locating the requested Web site resource at its new location and returning it in response to the original request directed to the old location, if possible.

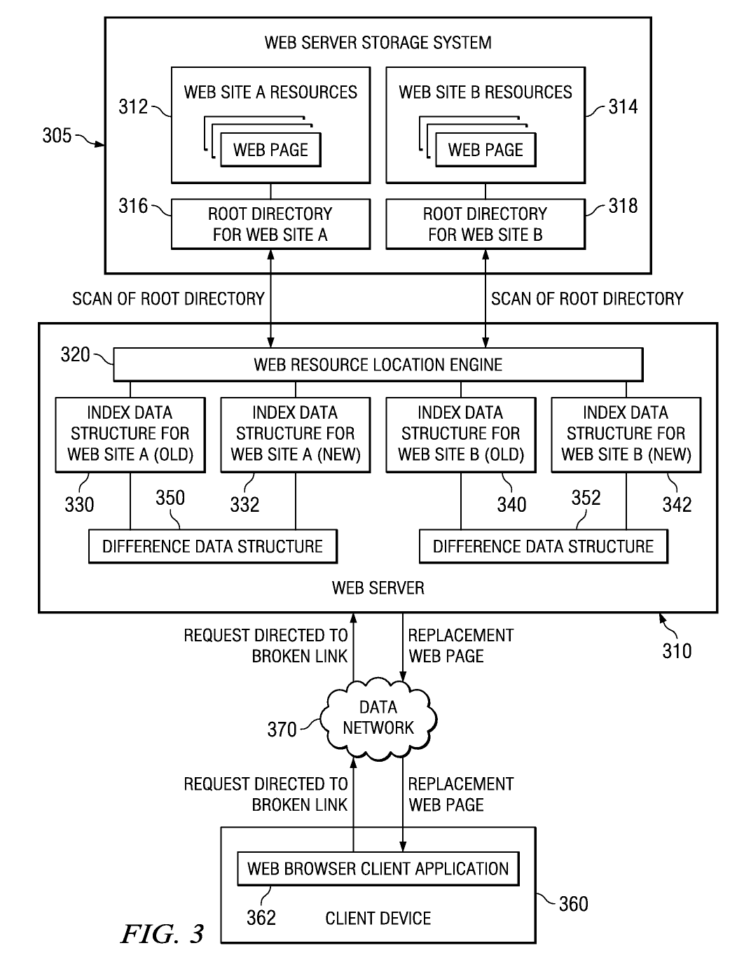

FIG. 3 is an exemplary diagram illustrating an operation of one illustrative embodiment with regard to handling a broken link to a Web site resource. As shown in FIG. 3, a Web resource location engine 320 of a Web server 310 periodically scans the root directories 316 and 318 of Web sites 312-314 hosted by the Web server 310, the resources of which may be stored in an associated Web server storage system 305. The Web resource location engine 320 generates index data structures 330-332 and 340-342 for the Web sites 312-314 based on the directory paths to the various Web site resources, which may comprise files, data structures, etc. but in the exemplary embodiments will be considered to be Web pages for illustration purposes, identified during scanning of the root directories 316 and 318.

As shown in FIG. 3, multiple index data structures 330-332 and 340-342 may be generated for each Web site 312-314 including at least one old index data structure 330, 340 and at least one new index data structure 332, 342. The old index data structures 330, 340 correspond to index data structures generated by a previous scanning of the root directory of the associated Web site 312-314. The new index data structures 332, 342 correspond to a most recent scan of the root directory of the associated Web site 312-314.

For example, the Web resource location engine 320 may have a scheduled time at which it performs scans of the root directories of the various hosted Web sites. Alternatively, a system administrator or other individual with sufficient privileges may manually request that such a scan of the root directories be performed. Moreover, in some illustrative embodiments, the Web resource location engine 320 may monitor a user's editing or modification of the structure to a Web site's resources and, in response to a determination that the Web site's structure has been modified, automatically initiate scanning of the root directory for that Web site so as to generate a new index data structure.

After creating the new index data structure 332, 342, the Web resource location engine 320 determines if a structure of the Web site resources has changed from a previous structure based on a comparison of the old index data structure 330, 340 to the new index data structure 332, 342. If the structure has changed, e.g., the location of a Web site resource has changed such as by moving a Web page to a different directory, for example, then an entry is added to a difference data structure 350, 352 identifying the new location for the Web site resource, e.g., the Web page. It should be noted that while FIG. 3 shows multiple difference data structures 350, 352 being used, i.e. one for each Web site, the invention is not limited to such and a single difference data structure that stores entries for all of the Web sites hosted by a Web server 310 may be used without departing from the spirit and scope of the present invention.

The difference data structures 350, 352 may store entries organized by a Web site resource identifier, such as a filename or the like, such that all of the entries corresponding to the same Web site resource may be associated with one another. Thus, for example, for a file having the filename “ondemand.pdf,” all entries for this file may be stored in the difference data structure 350, 352 in association with one another in an organized manner. Alternatively, entries may be added to the difference data structure 350, 352 in a continual manner without regard to the particular Web site resource identifier in which case entries for different Web site resources may be intermingled throughout the difference data structure 350, 352.

When a Web browser client application 362 of a client device 360 sends a request to the Web server 310 via the data network 370 for a Web site resource, e.g., a Web page, of a Web site hosted by the Web server 310, the Web server 310 first searches the Web server storage system 305 for the requested Web site resource at the location, e.g., directory, identified in the request. For example, the request may specify a Uniform Resource Locator (URL) that identifies a directory path to the Web site resource requested by the Web browser client application 362. This URL is used by the Web server 310 to search for the requested Web site resource. The request may be generated in response to a user of the client device 360 entering the URL in the Web browser client application 362 via a user interface, e.g., a keyboard, mouse, or the like, or by the user selecting a hyperlink or other link to the Web site resource via the Web browser client application 362, e.g., by selecting a bookmark maintained by the Web browser client application 362, selecting a hyperlink in a Web page being displayed by the Web browser client application 362, or the like.

If the requested Web site resource is present at the location specified by the request from the Web browser client application 362, then the Web server 310 returns the matched Web site resource to the Web browser client application 362 in a manner generally known in the art. If the Web server 310 cannot find the Web site resource at the location specified in the request, rather than returning an error response, e.g., a 404 error Web page stating that the requested Web page cannot be found, the Web resource location engine 320 is provided with the request and performs a search of a difference data structure 350, 352 corresponding to the Web site for which the request was received. Specifically, the Web resource location engine 320 searches the difference data structure for the document root, scanning earlier recorded entries in the difference data structure that match the original missing Web site resource's path structure and identifier, e.g., filename such as “ondemand.pdf” If a match cannot be found in the difference data structure 350, 352, then an error response may be returned to the Web browser client application 362.

If the Web resource location engine 320 locates the original path structure and Web site resource identifier in the differences data structure 350, 352, the Web resource location engine 320 retrieves the original consistency value, e.g., checksum or CRC value, of that Web site resource and looks up the new path structure for the Web site resource as documented in the differences data structure 350, 352. The Web resource location engine 320 then searches for the original Web site resource identifier in the new path structure and searches for a match to the original consistency value (e.g., checksum or CRC value).

If the Web resource location engine 320 finds a match based on the documented new Web site resource location, original Web site resource identifier, and original consistency value, the matching replacement Web site resource may be provided by the Web server 310 to the Web browser client application 362 as a suitable replacement for the Web site resource at the location specified in the original request, if a matching document root is found that can be used to access the new Web site resource location (providing a replacement Web site resource using a new URL is described hereafter). If the Web resource location engine 320 does not find a match, an error response may be returned to the Web browser client application 362.

In some instances, the Web resource location engine 320 may be able to find a match for a Web site resource's documented new location, identifier, and a matching document root to access the new Web site resource location, but may not be able to find an identical consistency value. In such a case, the Web resource location engine 320 may return a message to the Web browser client application 362 which is to be displayed to the user via the client device 360 indicating that the requested Web site resource is not available and requesting that the user indicate whether a possible replacement for the requested Web site resource should be returned or not. For example, a message such as “The requested page was not found. However, a possible replacement page has been found. Would you like to see the replacement page?” Appropriate user interface elements, e.g., virtual buttons or the like, may be provided via the Web browser client application 362 so that the user may respond with a “Yes” or “No” response. If the user responds “Yes”, then the replacement Web site resource may be returned to the Web browser client application 362 along with a new URL.

For example, a Web page faq.html may be updated frequently so that the file changes often and thus, the consistency value associated with the file will most likely not be the same. Moreover, the location of this Web page in the structure of the Web site may change as well. With the mechanisms of the illustrative embodiments, the new file location for faq.html will be found using the difference data structure 350, 352, but the file will most likely not have the same consistency value. In this case, the Web resource location engine 320 provides a message and an option to the user as to whether the Web page faq.html at the new location should be returned even though the consistency value does not match, i.e. provides an option to return a replacement Web page that may not be exactly the same as the original Web page referenced in the original request. If the user responds that they would like to receive the replacement Web page, the Web resource location engine 320 serves up the replacement Web site resource even though the consistency value does not match the original consistency value of the Web site resource.

In order to provide a replacement Web site resource, the Web resource location engine 320 examines the document root, or multiple document roots, to determine if a matching document root can be used to access the new file location and generate a new URL for the replacement Web site resource. For example, virtual hosting may be utilized in the Web server such that the Web server receives requests for more than one host. In such a case, a different DocumentRoot may be specified for each virtual host. The mechanisms of the illustrative embodiment may examine each of these document roots to determine the appropriate place from which to provide the replacement resource based on the requested resource's IP address, hostname, or the like. For example, assume that the Web server 310 provides virtual hosting of the following virtual hosts:

<VirtualHost *>
ServerName www.sitea.com
DocumentRoot /htdocs/sitea/
</VirtualHost>
<VirtualHost *>
ServerName www.siteb.com
DocumentRoot /htdocs/siteb/
</VirtualHost>

With these two virtual hosts, a Web browser client application may access the first virtual host resource at /htdocs/sitea/ondemand/whitepapers/strategy/ondemand.pdf with the URL http://www.sitea.com/ondemand/whitepapers/strategy/ondemand.pdf Moreover, the Web browser client application may access the second virtual host resource at /htdocs/siteb/ondemand/whitepapers/strategy/ondemand.pdf with the URL http://www.siteb.com/ondemand/whitepapers/strategy/ondemand.pdf

Whenever the Web resource location engine 320 locates an existing match, it creates a new URL to the Web site resource based on where the Web site resource is now located. For example, assume that the Web server 310 has the following document root set in its configuration file (not shown) for Web site A at http://www.ibm.com: DocumentRoot/htdocs. When a request is made for the outdated URL http://www.ibm.com/ondemand/whitepapers/ondemand.pdf, the Web resource location engine 320 can examine the differences data structure and using the new path of the requested ondemand.pdf file found at /htdocs/ondemand/whitepapers/strategy/ondemand.pdf, it may generate a new URL http://www.ibm.com/ondemand/whitepapers/strategy/ondemand.pdf and send it to the Web browser client application 362.

In addition, the Web resource location engine 320 may generate a log entry in a log data structure (not shown) of the Web server 310 indicating that a new URL was generated for a requested Web site resource. The log data structure may be used by the Web site administrator to keep track of the Web site resources that have moved with links or user requests to the original Web site resources. The Web site administrator may use this log data structure to aid in manually cleaning up the Web site by manually fixing broken links to Web site resources that have moved.

In some systems, such as UNIX based systems, for example, as an alternative illustrative embodiment, a replacement Web site resource directory, e.g., /htdocs/replacement_files, which contains a symbolic link to the Web site resource where it is currently located may also help to track links to, or requests for, a missing or moved Web site resource along with providing an indication of where the Web site resource may currently be found. A new URL may be generated for the Web site resource's symbolic link and sent back to the Web browser client application 362.

When an outdated URL is used and the Web resource location engine 320 finds an alternative path based on the new documented Web site resource location, original Web site resource identifier, and checksum or CRC value, the Web resource location engine 320 may create a replacement directory, if one has not already been created. The Web resource location engine 320 may further create, in the replacement directory, the symbolic link to the Web site resource at its current location. For example, a symbolic link /htdocs/replacement_file/ondemand.pdf may be generated that points to the new location for this Web site resource at /htdocs/ondemand/whitepapers/innovation/ondemand.pdf In this example, the Web resource location engine 320 may serve up the located file “ondemand.pdf” by using the symbolic link path structure and creating a new URL http://www.ibm.com/replacement_file/ondemand.pdf

Creating a replacement directory and establishing symbolic links has an added value to Web site administrators since they can easily examine the directory to determine which pages are getting automatic replacements. The Web site administrators may then fix the broken links based on the identification of these broken links in the replacement directory.

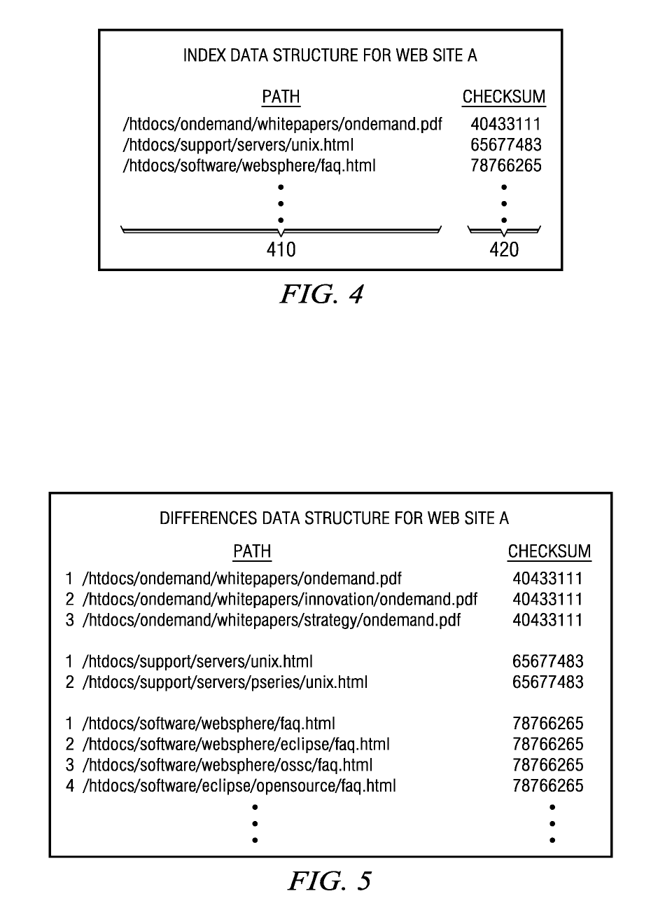

FIG. 4 is an exemplary diagram of an index data structure in accordance with one illustrative embodiment. As shown in FIG. 4, the index data structure is comprised of entries having a path structure 410 for each of the Web site resources of a Web site associated with a corresponding checksum or CRC value 420. Index data structures such as that shown in FIG. 4 may be generated at periodic times, in response to detected events, e.g., modification of a structure of the Web site, or in response to a user command to scan a root directory of the Web site. Index data structures for a Web site may be compared to generate entries in a differences data structure to identify movements of Web site resources within the Web site structure. Thus, for example, an entry in an old index data structure identifying the location of a Web site resource ondemand.pdf, having a checksum of 40433111, as being /htdocs/ondemand/whitepapers/ondemand.pdf may be compared to an entry in a new index data structure identifying the new location of the Web site resource ondemand.pdf with the checksum 40433111 as being /htdocs/ondemand/whitepapers/innovations/ondemand.pdf Since the two paths are different, an entry in a differences data structure is generated with the path in the new index data structure and the checksum or CRC value.

FIG. 5 is an exemplary diagram of a differences data structure in accordance with one illustrative embodiment. As shown in FIG. 5, the differences data structure comprises one or more entries for each of the Web site resources whose locations have changed in the Web site structure. The differences data structure in the depicted example is organized such that entries identifying the path changes for a particular Web site resource are stored in the differences data structure in association with one another. Thus, for example, for the “ondemand.pdf” Web site resource, a first entry “1/htdocs/ondemand/whitepapers/ondemand.pdf 40433111” identifies an original location of the “ondemand.pdf” Web site resource. The second entry “2 /htdocs/ondemand/whitepapers/innovation/ondemand.pdf 40433111” identifies a relocation of the “ondemand.pdf” Web site resource to a new location. Similarly, the third entry identifies a movement of the “ondemand.pdf” Web site resource to a new location at/htdocs/ondemand/whitepapers/strategy/ondemand.pdf Similar entries for other Web site resources are also shown in FIG. 5.

As described above, when searching the differences data structure for a particular Web site resource, such as “ondemand.pdf,” the Web resource location engine 320 may search the earlier entries, i.e. the entries corresponding to the original location of the Web site resource, for the document root and Web site resource identifier corresponding to the URL specified in a received request. When the first entry “1/htdocs/ondemand/whitepapers/ondemand.pdf 40433111” is found as matching the document root and Web site resource identifier of the request, the Web resource location engine 320 retrieves the consistency value, e.g., checksum or CRC value, associated with the first entry, i.e. 40433111. The Web resource location engine 320 then searches for the Web site resource identifier, e.g., the filename ondemand.pdf, in the new path locations specified in associated entries in the difference data structure which have a matching consistency value, e.g., checksum or CRC value. The newest entry, e.g., the last associated entry, for that Web site resource is then selected for returning the replacement Web site resource to the Web browser client application 362 from which the original request was received.

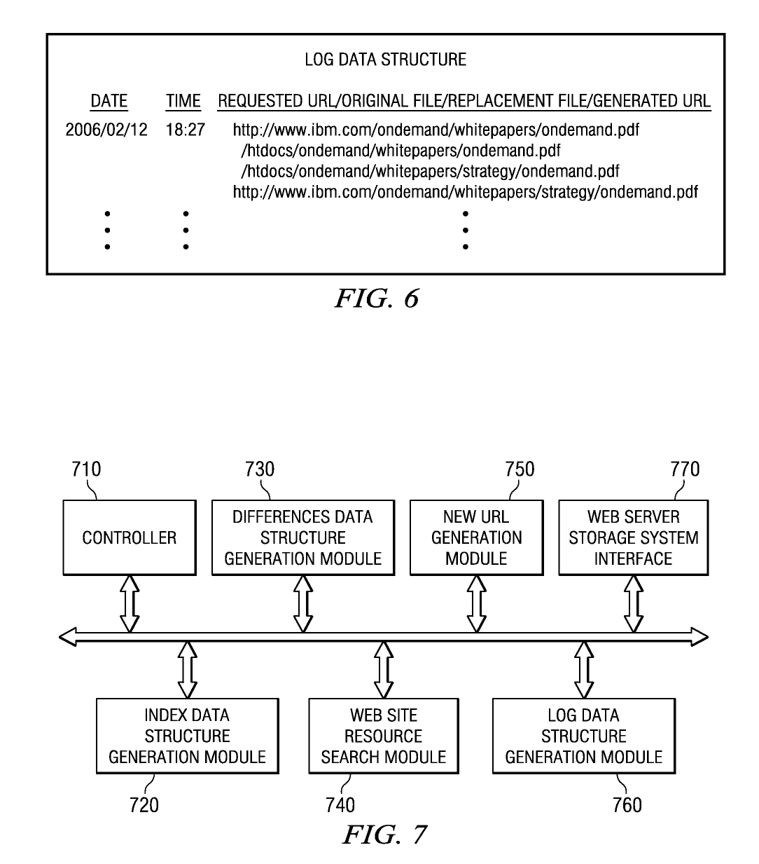

FIG. 6 is an example of a log data structure in accordance with one illustrative embodiment. The log data structure may be used, as described above, to provide a log of the generation of new URLs for relocated Web site resources in order to aid a Web site administrator in fixing broken links within the Web site. As shown in FIG. 6, the log data structure comprises entries that include a date, time, and Web site resource information identifying a change in the URL for a requested Web site resource. The Web site resource information may identify, for example, the requested URL, the original Web site resource location, a corresponding found replacement Web site resource location, and the new URL generated for the replacement Web site resource location. This information may be stored and used at a convenient time for quickly identifying which links to which resources need to be fixed in the Web site.

FIG. 7 is an exemplary block diagram of the primary operational components of a Web site resource location engine in accordance with one illustrative embodiment. The elements shown in FIG. 7 may be implemented as hardware, software, or any combination of hardware and software. In one illustrative embodiment, the operational elements shown in FIG. 7 are implemented as software instructions executed on one or more processors.

As shown in FIG. 7, the Web site resource location engine includes a controller 710, an index data structure generation module 720, a differences data structure generation module 730, a Web site resource search module 740, a new URL generation module 750, a log data structure generation module 760, and a Web server storage system interface 770. The controller 710 controls the overall operation of the Web site resource location engine and orchestrates the operation of the other elements 720-770. The controller 710, at predetermined periodic times, in response to a detected event, or in response to a command from a user, may instruct the index data structure generation module 720 to scan the root directory of the Web sites hosted by the Web server with which the Web site resource location engine is associated via the Web server storage system interface 770. The index data structure generation module 720 may then generate one or more index data structures based on the results of scanning the root directory of the Web sites. The controller 710 may then instruct the differences data structure generation module 730 to compare an old index data structure (if one exists) with the newly generated index data structure to generate a differences data structure entry for each Web site resource identified in the Web site structure.

In response to receiving a request directed to a broken link, the controller 710 instructs the Web site resource search module 740 to search for a replacement Web site resource using the differences data structure generated by the differences data structure generation module 730 based on the index data structures generated by the index data structure generation module 720. In the event that a replacement Web site resource is found through the search, the controller 710 may return the replacement Web site resource to the requester client device. Alternatively, if a replacement Web site resource is not found, then an error response may be returned. In returning the replacement Web site resource, the new URL generation module 750 may generate a new URL for the replacement Web site resource based on the current location of the replacement Web site resource. This URL may be used to return the replacement Web site resource to the requestor client device. Moreover, the new URL may be logged in a log entry generated by the log data structure generation module 760, as previously described above. As mentioned above, this log data structure may be used to inform the Web site administrator of broken links that need to be fixed in order to improve responsiveness of the Web site to requests for the Web site resources associated with the broken links.

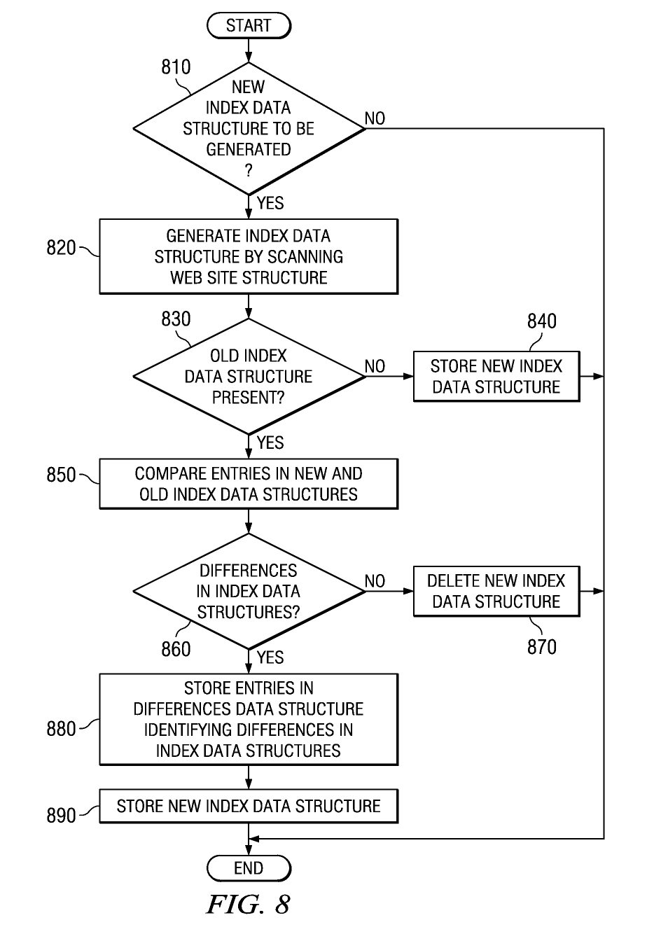

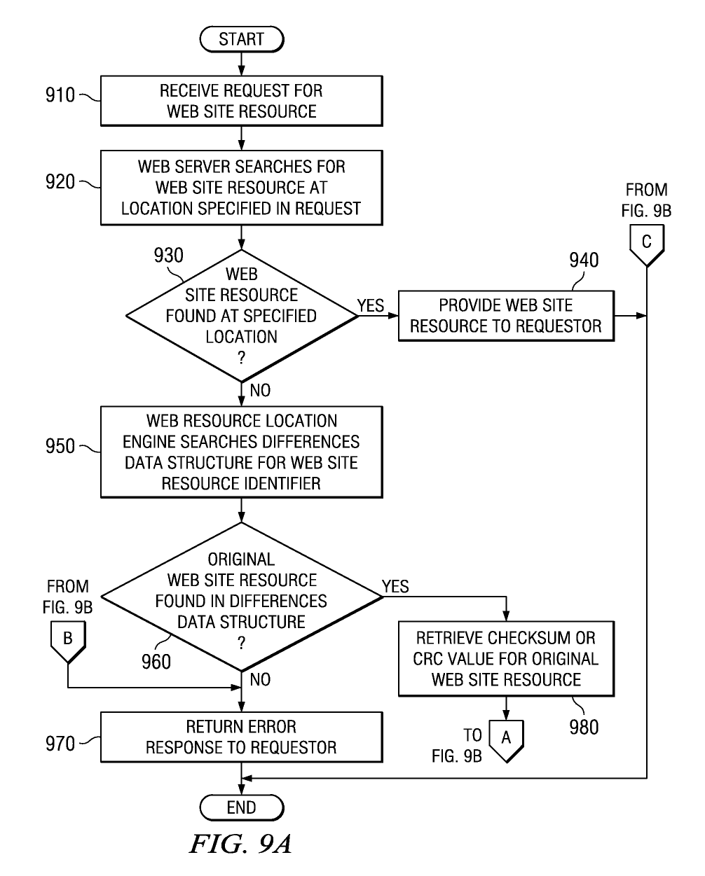

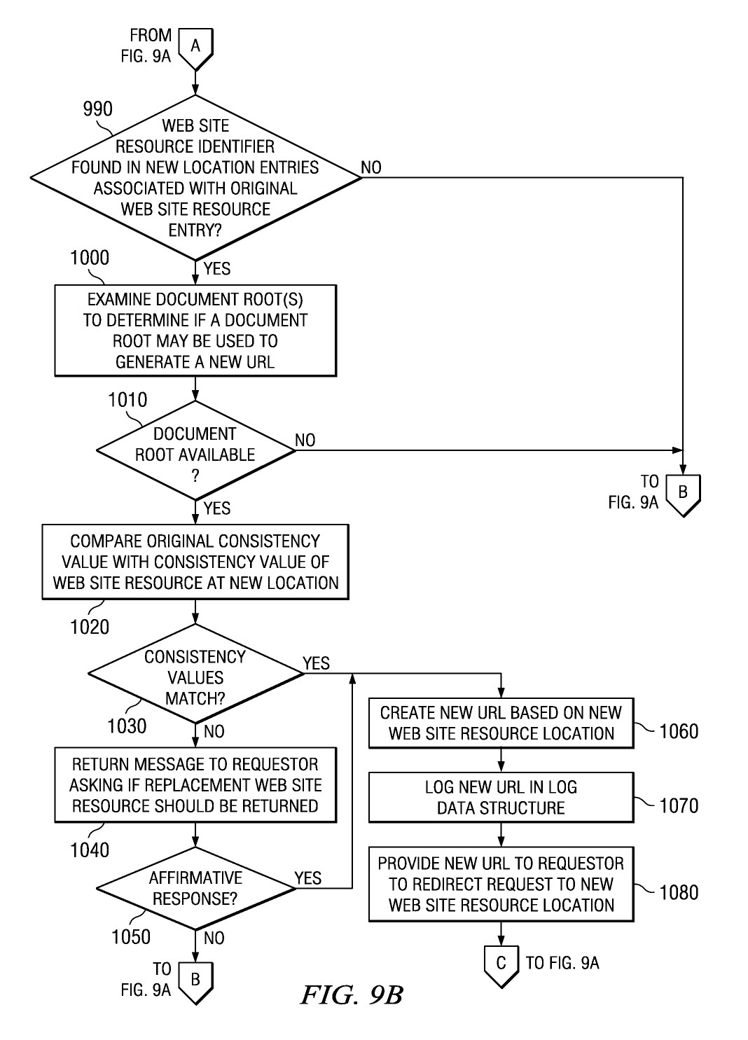

FIGS. 8 and 9A-9B are flowcharts outlining exemplary operations of a Web site and/or Web site resource location engine in accordance with one illustrative embodiment. It will be understood that each block of the flowchart illustrations, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or by combinations of special purpose hardware and computer instructions.

Furthermore, the flowcharts are provided to demonstrate the operations performed within the illustrative embodiments. The flowcharts are not meant to state or imply limitations with regard to the specific operations or, more particularly, the order of the operations. The operations of the flowcharts may be modified to suit a particular implementation without departing from the spirit and scope of the present invention.

FIG. 8 is a flowchart outlining an exemplary operation for automatically generating an index and differences data structure in accordance with one illustrative embodiment. As shown in FIG. 8, the operation starts with the Web site resource location engine determining if a new index data structure is to be generated for a Web site (step 810). As discussed above, such a determination may be made based on a regularly scheduled time period for which index data structures are to be generated, in response to a detected event, such as a modification of a Web site's structure, in response to receiving a user input instructing the Web site resource location engine to generate a new index data structure, or the like. If it is not time to generate a new index data structure, the operation terminates.

If it is time to generate a new index data structure for the Web site, the Web site resource location engine generates an index data structure from the document root by scanning the structure of the Web site (step 820). The Web site resource location engine determines if there is an old index data structure for the Web site (step 830). If not, the new index data structure is stored (step 840) and the operation terminates. If an old index data structure is present, the Web site resource location engine compares entries in the old index data structure and the new index data structure (step 850).

The Web site resource location engine determines if there are in fact any differences between the new index data structure and the old index data structure with regard to Web site resources of the Web site, e.g., Web site resources having been moved within the Web site structure (step 860). If not, the new index data structure may be deleted (step 870). Alternatively, rather than deleting the new index data structure, the old index data structure may always be deleted in favor of the new index data structure. If there are differences between the old index data structure and the new index data structure, the Web site resource location engine stores entries corresponding to the differences in a differences data structure (step 880) and stores the new index data structure, which will be used as the old index data structure in a subsequent iteration of the operation (step 890). The operation then terminates.

FIGS. 9A-9B are flowcharts outlining an exemplary operation for locating a Web site resource in accordance with one illustrative embodiment. As shown in FIGS. 9A-9B, the operation starts with the Web server receiving a request for a Web site resource (step 910). The request may be received, for example, from a Web browser client application of a client device, such as in response to a user entering a URL for a Web site resource desired by the user, user selection of a hyperlink or other link to the Web site resource in a Web page, user selection of a stored bookmark, or the like. In response to receiving the request, the Web server searches for the corresponding Web site resource at the location specified in the request (step 920). The Web server determines if the Web site resource is found in the original location (step 930). If the Web site resource is found at the original location, the Web server provides the Web site resource to the requestor (step 940) and the operation terminates.

If the Web site resource is not found at the original location, the Web site resource location engine searches, in the document root of the differences data structure, for the Web site resource to find the original directory structure and Web site resource identifier that maps to the requested Web site resource (step 950). The Web site resource location engine determines if the original Web site resource structure and Web site resource identifier are found in the differences data structure (step 960). If not, the Web server returns an error response to the requester, e.g., a 404 page not found error Web page (step 970) and the operation terminates.

If the original Web site resource structure and Web site resource identifier are found in the differences data structure, the Web site resource location engine retrieves the consistency value, e.g., checksum or CRC value, for the original Web site resource and searches for the Web site identifier in the new path entries corresponding to the found original Web site resource structure (step 980). The Web site resource location engine determines if a Web site resource identifier is found in the new path entries that corresponds to the original Web site resource identifier (step 990). If not, the operation branches to step 970 where an error message is returned to the requestor.

If a Web site resource identifier is found in the new path entries that corresponds to the original Web site resource identifier, the Web site resource location engine examines the document root, or multiple document roots, to determine if a document root can be used to generate a new URL for the Web site resource in its new location (step 1000). The Web site resource location engine determines if such a document root exists (step 1010) and if not, the operation again branches to step 970 and returns an error message.

If a document root is available for use in providing a new URL to access the Web site resource at the new location, the Web site resource location engine compares the original consistency value, e.g., checksum or CRC value, with that of the Web site resource at the new location found during the search of the differences data structure (step 1020). The Web site resource location engine determines if the consistency values match (step 1030). If the consistency values do not match, the Web site resource location engine returns a message to the requestor stating that the request Web site resource was not found but that a replacement has been located and asks whether the user wishes to receive the replacement (step 1040). The Web site resource location engine determines if the user's response is affirmative or not (step 1050). If the user's response is negative, then the operation again branches to step 970 and an error message is returned to the requester.

If the user's response is affirmative, or if the consistency values match, the Web site resource location engine creates a new URL based on the new Web site resource location and its currently existing document root (step 1060). The Web site resource location engine may then log the request for the old URL along with the new Web site resource location and the new URL in a log data structure for later use by a Web site administrator, or the like (step 1070). The Web server may then send the new URL to the Web browser client application from which the original request was received to thereby redirect the Web browser client application to the Web site resource at its new location (step 1080). The operation then terminates.

It should be noted that, is some instances, a user or client device requesting access to a resource via a broken link may not have sufficient permissions in place for accessing the resource at its new location. With the mechanisms of the illustrative embodiments, security measures may be provided for checking a level of access to be afforded to a user or client device attempting to access a resource via a broken link before providing the replacement resource from the new location. For example, after locating the replacement resource via the mechanisms described above, but prior to providing the replacement resource to the Web browser client application, the Web server may check the permissions associated with the identity of the user or the client device to ensure that sufficient permissions are allocated to the user of the client device to receive the replacement resource. Such permissions type checking is generally known in the art, but has not been applied to providing replacement resources for broken links as in the illustrative embodiments.

Such checks may also be performed at other times in the operation of providing a replacement resource, such as when sending a message to the user to ask if they would like a replacement resource provided that does not exactly match the requested resource. With such an embodiment, the permission check is made prior to sending the request to the user and if the permission check fails, the request is not sent to the user and an error message may be returned. If the permission check succeeds, then the operation may continue as previously described above. Other mechanisms for ensuring that a requestor of a resource via a broken link is permitted to access the replacement resource may be used without departing from the spirit and scope of the present invention.

Thus, the illustrative embodiments provide a system and method in which mechanisms are provided for searching for Web site resources that have been moved to a new location in a Web site structure in response to receiving a request directed to an old location of the Web site resource, such as via a broken link. The mechanisms of the illustrative embodiments alleviate the frustration often encountered by users when they access old links or bookmarks that would typically return an error message. With the mechanisms of the illustrative embodiments, rather than returning the error message, the illustrative embodiments attempt to locate the new location of the Web site resource and redirect the user's Web browser client application to the new location if found, thereby avoiding the automatic sending of an error message.

It should be appreciated that the illustrative embodiments may take the form of an entirely hardware embodiment, an entirely software embodiment or an embodiment containing both hardware and software elements. In one exemplary embodiment, the mechanisms of the illustrative embodiments are implemented in software, which includes but is not limited to firmware, resident software, microcode, etc.

Furthermore, the illustrative embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for locating a Web site resource of a Web site, comprising:
receiving a request for the Web site resource, wherein the request specifies a first location of the Web site resource;
determining if the Web site resource is present at the first location;
searching a differences data structure for the Web site resource if the Web site resource is not present at the first location, wherein the differences data structure comprises entries identifying relocation of the Web site resource within a structure of a Web site; and
providing a replacement Web site resource, corresponding to the Web site resource requested in the request, in response to finding the Web site resource in the differences data structure, wherein the replacement Web site resource is located at a second location within the structure of the Web site different from the first location.

2. The method of claim 1, further comprising:
indexing Web site resources of the Web site to thereby generate an index data structure identifying a current location of Web site resources of the Web site; and
generating the differences data structure based on the index data structure.

3. The method of claim 2, wherein generating the differences data structure comprises:
comparing the index data structure to a previously generated index data structure;
identifying one or more differences in location of Web site resources based on the comparison of the index data structure to the previously generated index data structure; and
storing one or more entries in the differences data structure identifying a current location of Web site resources based on the one or more identified differences in location of Web site resources.

4. The method of claim 2, further comprising monitoring editing or modification of a structure of the Web site, wherein indexing Web site resources is automatically performed in response to a determination that the structure of the Web site has been modified.

5. The method of claim 2, wherein the index data structure comprises one or more entries, each entry having a full path name of a Web site resource and a consistency value generated based on content of the Web site resource.

6. The method of claim 1, wherein the differences data structure comprises a group of entries for at least one Web site resource, and wherein the group of entries for the at least one Web site resource identifies a history of locations of the Web site resource in a structure of the Web site.

7. The method of claim 1, wherein searching a differences data structure comprises:
searching the differences data structure for an entry that matches a path structure and resource identifier of the Web site resource;
determining if a matching entry in the differences data structure is found; and
returning an error response if a matching entry is not found.

8. The method of claim 7, wherein searching a differences data structure further comprises:
retrieving an original consistency value from the matching entry if a matching entry in the differences data structure is found;
identifying a new path structure entry for the Web site resource by performing a look-up operation in the differences data structure based on the filename of the Web site resource;
comparing the original consistency value to a consistency value associated with the new path structure entry; and
returning the new path structure entry as the second location of the Web site resource if the original consistency value matches the consistency value associated with the new path structure entry.

9. The method of claim 8, further comprising:
sending a prompt message to an originator of the request for the Web site resource in response to the original consistency value not matching the consistency value associated with the new path structure entry, the prompt message requesting that a user indicate whether a replacement Web site resource whose consistency value does not match an original consistency value of the Web site resource should be provided.

10. A computer program product comprising a computer useable medium having a computer readable program, wherein the computer readable program, when executed on a computing device, causes the computing device to:
receive a request for the Web site resource, wherein the request specifies a first location of the Web site resource;
determine if the Web site resource is present at the first location;
search a differences data structure for the Web site resource if the Web site resource is not present at the first location, wherein the differences data structure comprises entries identifying relocation of the Web site resource within a structure of a Web site; and
provide a replacement Web site resource, corresponding to the Web site resource requested in the request, in response to finding the Web site resource in the differences data structure, wherein the replacement Web site resource is located at a second location within the structure of the Web site different from the first location.

11. The computer program product of claim 10, wherein the computer readable program further causes the computing device to:
index Web site resources of the Web site to thereby generate an index data structure identifying a current location of Web site resources of the Web site; and
generate the differences data structure based on the index data structure.

12. The computer program product of claim 11, wherein the computer readable program causes the computing device to generate the differences data structure by:
comparing the index data structure to a previously generated index data structure;
identifying one or more differences in location of Web site resources based on the comparison of the index data structure to the previously generated index data structure; and
storing one or more entries in the differences data structure identifying a current location of Web site resources based on the one or more identified differences in location of Web site resources.

13. The computer program product of claim 11, wherein the computer readable program further causes the computing device to monitor editing or modification of a structure of the Web site, and wherein indexing Web site resources is automatically performed in response to a determination that the structure of the Web site has been modified.

14. The computer program product of claim 11, wherein the index data structure comprises one or more entries, each entry having a full path name of a Web site resource and a consistency value generated based on content of the Web site resource.

15. The computer program product of claim 10, wherein the differences data structure comprises a group of entries for at least one Web site resource, and wherein the group of entries for the at least one Web site resource identifies a history of locations of the Web site resource in a structure of the Web site.

16. The computer program product of claim 10, wherein the computer readable program causes the computing device to search a differences data structure by:
searching the differences data structure for an entry that matches a path structure and resource identifier of the Web site resource;
determining if a matching entry in the differences data structure is found; and
returning an error response if a matching entry is not found.

17. The computer program product of claim 16, wherein the computer readable program further causes the computing device to search a differences data structure by:
retrieving an original consistency value from the matching entry if a matching entry in the differences data structure is found;
identifying a new path structure entry for the Web site resource by performing a look-up operation in the differences data structure based on the filename of the Web site resource;
comparing the original consistency value to a consistency value associated with the new path structure entry; and
returning the new path structure entry as the second location of the Web site resource if the original consistency value matches the consistency value associated with the new path structure entry.

18. The computer program product of claim 17, wherein the computer readable program further causes the computing device to:
send a prompt message to an originator of the request for the Web site resource in response to the original consistency value not matching the consistency value associated with the new path structure entry, the prompt message requesting that a user indicate whether a replacement Web site resource whose consistency value does not match an original consistency value of the Web site resource should be provided.

19. A data processing system, comprising:
a processor; and
a memory coupled to the processor, the memory comprising instructions which, when executed by the processor, cause the processor to:
receive a request for a Web site resource of a Web site, wherein the request specifies a first location of the Web site resource;
determine if the Web site resource is present at the first location;
search a differences data structure for the Web site resource if the Web site resource is not present at the first location, wherein the differences data structure comprises entries identifying relocation of the Web site resource within a structure of a Web site; and
provide a replacement Web site resource, corresponding to the Web site resource requested in the request, in response to finding the Web site resource in the differences data structure, wherein the replacement Web site resource is located at a second location within the structure of the Web site different from the first location.

20. The system of claim 19, wherein the instructions further cause the processor to:
index Web site resources of the Web site to thereby generate an index data structure identifying a current location of Web site resources of the Web site; and
generate the differences data structure based on the index data structure, wherein the differences data structure is generated by:
comparing the index data structure to a previously generated index data structure;
identifying one or more differences in location of Web site resources based on the comparison of the index data structure to the previously generated index data structure; and
storing one or more entries in the differences data structure identifying a current location of Web site resources based on the one or more identified differences in location of Web site resources.
